(19) United States
(12) Patent Application Publication
(10) Pub. No.: US 2012/0047001 A1
(43) Pub. Date: Feb. 23, 2012

(54) Valet Parking Management System

(76) Inventor: Theodore Chagnon, Granby, MA (US)

(21) Appl. No.: 13/215,054

(22) Filed: Aug. 22, 2011

Related U.S. Application Data
(60) Provisional application No. 61/375,487, filed on Aug. 20, 2010.

(51) Int. Cl. G07B 15/00

(52) U.S. Cl. 705/13

(57) ABSTRACT

A method of maintaining a valet parking database in a distributed computing system that includes a plurality of work stations each connected via a packet switched network to a computing device that accesses the valet parking database including information associated with vehicles that are valet parked, comprises assigning a uniquely associated tracking code to a vehicle to be valet parked. A record in the valet parking database associated with the tracking code is created, and a parking timer associated with the tracking code is automatically activated to indicate the elapsed time since the vehicle to be valet parked has been assigned the tracking code but is not yet parked. A warning message is automatically issued if the parking timer exceeds a first value indicating that the vehicle to be valet parked has not yet been parked. The record is updated to indicate that the vehicle has been parked and the parking timer is deactivated when the vehicle to be valet parked has been parked. When a retrieve vehicle request associated with the tracking code is received the record from the valet parking database associated with the tracking code is retrieved, and a key timer associated with the retrieved record is activated to indicate the elapsed time since the record has been automatically retrieved in response to the retrieve vehicle request. A missing key warning message is automatically generated if the key timer exceeds a second value indicating that the vehicle key has not yet been retrieved. The record is updated and the key timer is deactivated when the key associated with the vehicle to be valet parked has been located.

### CROSS REFERENCE TO RELATED APPLICATIONS

This application claims priority from the provisional application designated Ser. No. 61/375,487 filed Aug. 20, 2011 and entitled “Valet Parking Management System”, which is hereby incorporated by reference.

### BACKGROUND OF THE INVENTION

The present invention relates to the field of valet parking, and in particular to a valet parking management system that tracks vehicles and the productivity of valet parking personnel.

The use of computerized valet parking management systems is known. However, there is a need for a system that more closely tracks the movement of customer vehicles.

### SUMMARY OF THE INVENTION

A method of maintaining a valet parking database in a distributed computing system that includes a plurality of work stations each connected via a packet switched network to a computing device that accesses the valet parking database including information associated with vehicles that are valet parked, comprises assigning a uniquely associated tracking code to a vehicle to be valet parked. A record in the valet parking database associated with the tracking code is created, and a parking timer associated with the tracking code is automatically activated to indicate the elapsed time since the vehicle to be valet parked has been assigned the tracking code but is not yet parked. A warning message is automatically issued if the parking timer exceeds a first value indicating that the vehicle to be valet parked has not yet been parked. The record is updated to indicate that the vehicle has been parked and the parking timer is deactivated when the vehicle to be valet parked has been parked. When a retrieve vehicle request associated with the tracking code is received the record from the valet parking database associated with the tracking code is retrieved, and a key timer associated with the retrieved record is activated to indicate the elapsed time since the record has been automatically retrieved in response to the retrieve vehicle request. A missing key warning message is automatically generated if the key timer exceeds a second value indicating that the vehicle key has not yet been retrieved. The record is updated and the key timer is deactivated when the key associated with the vehicle to be valet parked has been located.

These and other objects, features and advantages of the present invention will become more apparent in light of the following detailed description of preferred embodiments thereof, as illustrated in the accompanying drawings.

### DESCRIPTION OF THE DRAWING

FIG. 1 is a pictorial illustration of a distributed valet parking management system;

FIG. 2 is a flow chart illustration of processing performed by the system illustrated in FIG. 1 and associated with valet parking of a vehicle;

FIGS. 3A and 3B are flow chart illustrations of processing performed by the system illustrated in FIG. 1 and associated with retrieving a valet parked vehicle; and

FIG. 4 is a pictorial illustration of a valet ticket.

### DESCRIPTION OF THE INVENTION

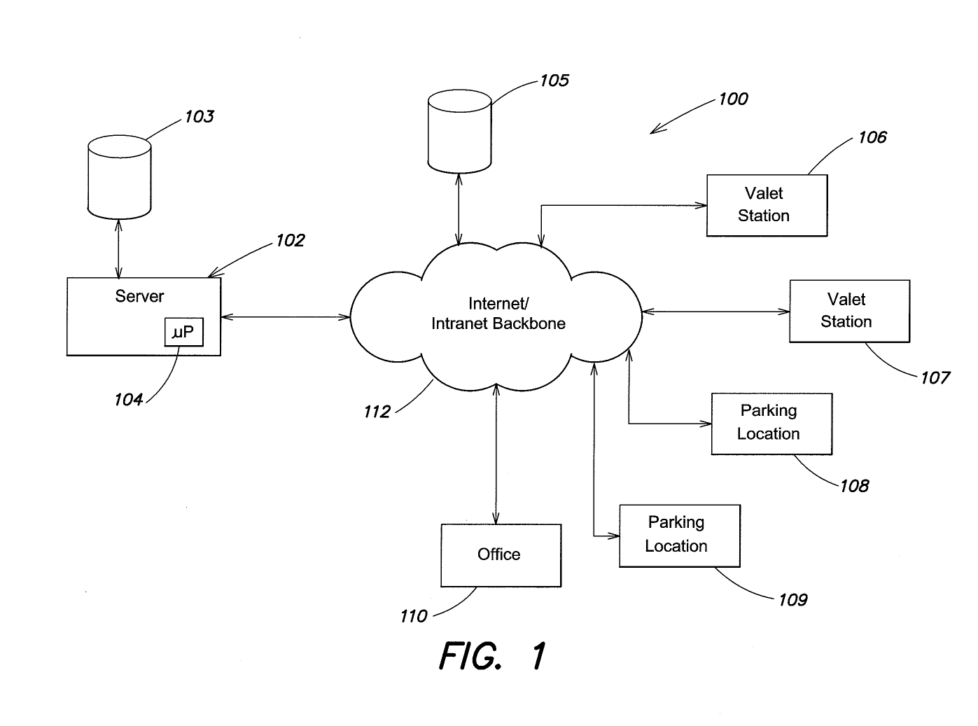

FIG. 1 is a pictorial illustration of a distributed valet parking management system 100. The system includes a server 102 having a memory 103 that contains executable program instructions and a processor 104 that executes the executable program instructions. The system also includes a valet parking management system database 105 that may be located in the memory device 103 or located remotely. The server 102 may include a display and input/output devices (e.g., keyboard, mouse, printer, flash drives, et cetera). The system 100 also includes valet drop-off/pick-up stations 106, 107 and parking locations 108, 109. In addition, the system may include an office station 110 that allows a manager to monitor the activity at the system locations, and communicate with the employees at those locations. Each of the valet stations 106, 107 and the parking locations 108, 109 includes a work station having a computer (e.g., a PC, laptop, tablet, handheld computing device, et cetera) and an optical ticket scanner, RFID reader or other device for retrieving information encoded on and/or within a valet parking ticket to be discussed. Each work station 106-110 communicates (e.g., via a wireless network or a wire line network) over a packet switched network 112 (e.g., the internet) with the server 102.

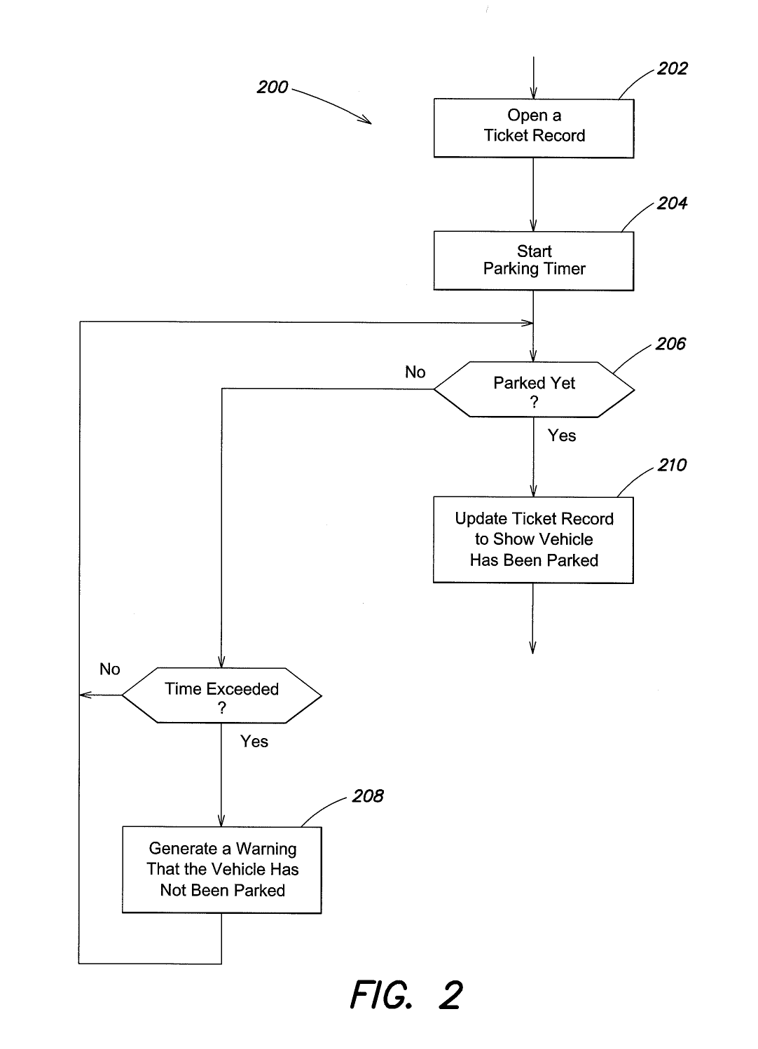

FIG. 2 is a flow chart illustration of processing steps 200 performed by the system illustrated in FIG. 1. When a vehicle arrives at the valet station, the valet attendant activates a ticket, which is then uniquely associated with the vehicle.

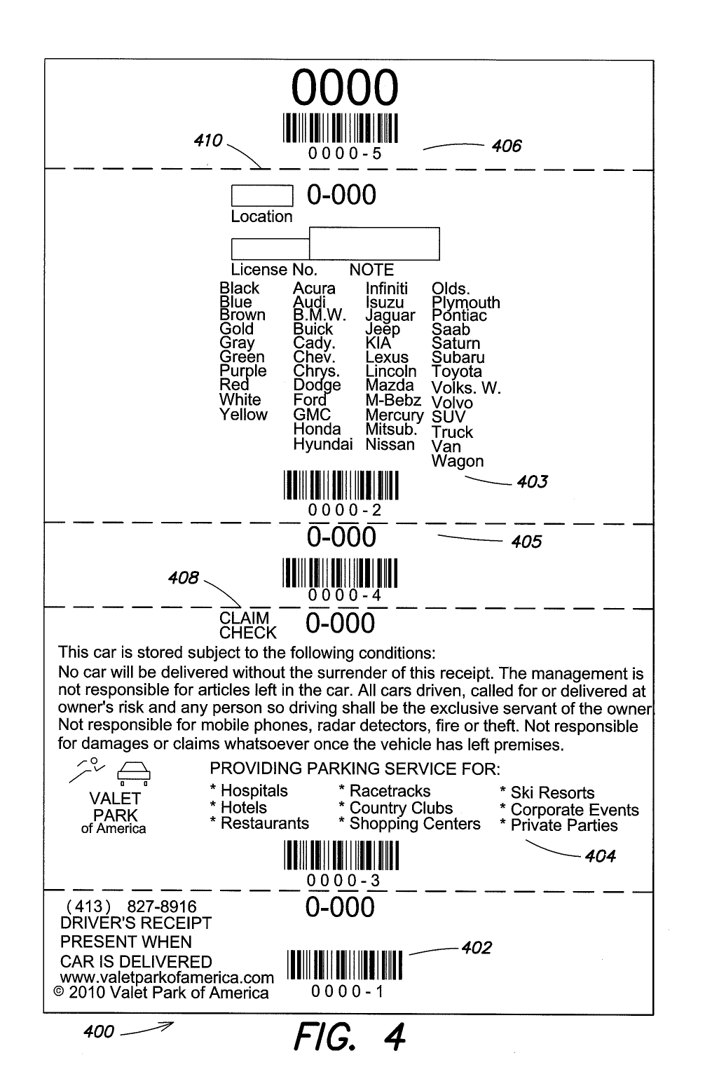

FIG. 4 illustrates an example of a paper ticket 400. Notably, the ticket includes a plurality of bar code fields 402-406, each containing a unique barcode that includes a primary numerical designator and a secondary numerical designator. For example, as shown in FIG. 4, the primary numerical designator for this particular ticket is 0000, each of the fields 402-406 includes its own secondary numerical designator -1, -2, -3, -4 and -5 respectively. It is contemplated that the ticket may include RFID encoded data or other encoded data, and rather than paper the data may be placed on or encoded within any relatively inexpensive substrate suitable for such applications. In addition, it is contemplated that the system may also be paperless and for example rely upon email or messaging (e.g., SMS) for example to share information between a client and the valet.

Referring to FIGS. 2 and 4, the ticket is activated by scanning the field 402 at the valet station, which causes the server 102 in step 202 to open a record for that particular ticket number. When the ticket is activated in the system, the time the vehicle arrived and what valet greeted the vehicle is recorded in the ticket record. The valet attendant separates the ticket 400 by tearing along a perforation 408, and gives the customer the ticket stub containing fields 402 and 404. A second ticket stub portion containing fields 403, 405 is attached to the vehicle key/fob. The valet also separates the ticket 400 along a second perforation 410, and places dash ticket stub 405 on the dash board of the vehicle and visible from outside the vehicle. Information (e.g., vehicle make, model, year, color and/or license plate number, et cetera) may also be entered into the ticket record within the system. In addition, the valet handwrites the license plate number of the vehicle, and perhaps other tracking information into data fields shown in the ticket field 403 that is attached to the keys.

Once a ticket is activated, a timer is started in step 204. The system checks in step 206 to determine if the vehicle has been parked (e.g., moved from the valet drop-off location to a parking location). For example, if the vehicle record has not been updated within a predetermined time to indicate the vehicle has been parked (e.g., at one of the parking locations), then in step 208 the server updates the record to record the event and generates a warning message that the vehicle has not been parked. The warning message may be displayed on the display of the work station at the valet drop-off location, and an audio message may also be provided if appropriate for the particular location. Advantageously, in addition to monitoring the queue of vehicles to be parked, this warning feature assists in quickly identifying if vehicle keys are missing.

When a valet parks the vehicle in a system parking lot, he scans the second field 403 (FIG. 4) that is attached to the keys and the vehicle record is again updated in step 210 to indicate the vehicle has been parked, at what time it as parked, and who parked the vehicle. The server 102 (FIG. 1) maintains an inventory of which ticket numbers/vehicles are parked in each parking lot, which facilitates tracking how many vehicles are parked each hour and maintaining a current and past inventory of the number of vehicles in the parking lot to manage personnel staffing levels. When a ticket is scanned the valet also scans his employee number (e.g., each employee has a card with the employee's number bar code on it), thus allowing the ticket record to include information on what valet(s) handled the vehicle. Advantageously, if questions arise regarding who handled a particular vehicle, the information is available from the valet parking management system database. The system may track employee productivity with various reports, for example, on how many cars an employee parks and/or retrieves hourly. In addition, since each employee has a card (e.g., RFID, key fob, et cetera) with his employee number encoded on it, the database may include information regarding when each employee clocks in and out. In addition, the system may include fields in each employee's record associated with compliments, complaint and/or accidents.

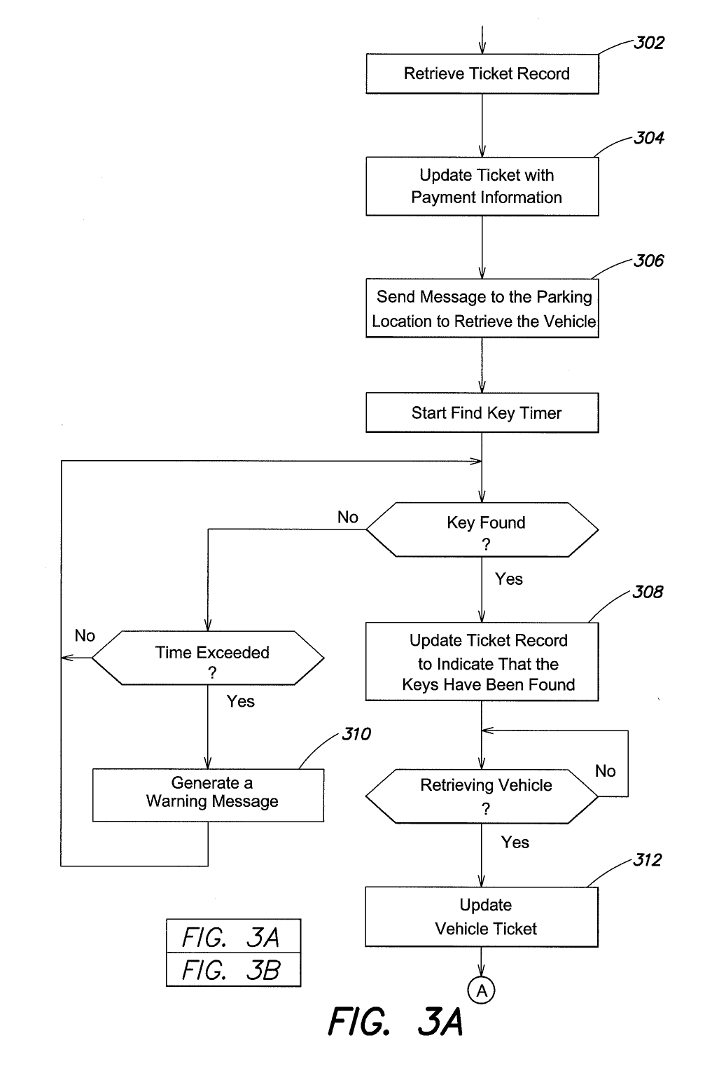

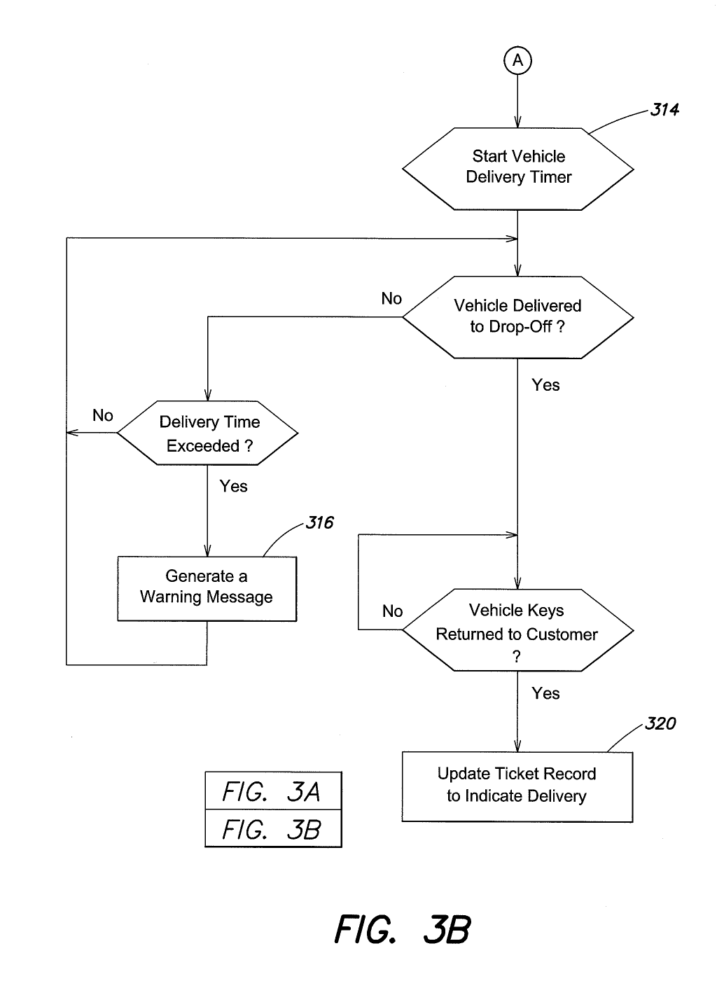

Referring to FIGS. 3A, 3B and 4, when a customer is ready to leave he presents his portion of the ticket 400 and field 404 is scanned (e.g., at the vehicle pick-up location), causing the vehicle record to be retrieved in step 302. Depending upon the billing model of a particular parking location, the system may prompt the cashier to enter a rate or validation code. The rate may also be automatically generated by the server in response to the ticket being scanned, and the amount due can be automatically displayed. The amount paid by the customer is recorded in the ticket record in step 304. Storing such information facilitates generating reports on sales by shift, day, week, month, et cetera.

In response to the ticket being scanned, in step 306 the server generates and transmits a request to the parking lot work station where the vehicle is located. The request may appear, for example, on the display of the parking lot work station as message such as “RETRIEVE VEHICLE #______ AND DELIVER TO ______ ENTRANCE” and at the office 110 (FIG. 1). Keys are typically stored in the parking lot where the vehicle has been parked, and in response to receiving this message, the valet takes the keys for the requested vehicle and scans the field 403 of the ticket. In step 308 the system then updates the ticket record to indicate that the keys have been located. If the keys are not found with a certain time after sending the message to the parking location to retrieve the vehicle, then a warning is generated in step 310, and the record is updated to record the event.

When valet is ready to retrieve the vehicle in the parking lot, the valet may again scan the field 403 of the ticket attached to the keys. The valet who will retrieve the vehicle also scans his employee badge and in step 312 the vehicle record is updated to indicate the date and time the vehicle is being retrieved and by who. This feature may be used to track the productivity of individual employees. A timer can also be started in step 314 to assist in monitoring how long it takes to retrieve the vehicle.

When the vehicle arrives at the pick-up location, the ticket may again be scanned and the ticket record is updated in step 316 to show that the vehicle is at the drop-off location. If the vehicle is not delivered within a certain time after the start of the vehicle delivery timer, then a warning message is generated by the server in step 316, and the record is updated. When the keys are returned to the vehicle driver, then in step 320 the vehicle record is updated to indicate date, time and location that the vehicle was been returned to the customer.

A computer screen at each location displays the number of vehicles to retrieve, which allows a manager at the valet location or the offices to dispatch valets to the appropriate parking lot locations on an as needed basis.

When there are no parking spaces available to park the vehicle, then it may be necessary to temporarily place vehicles (double parked) behind or in front of another vehicle. Generally keys may be left in the vehicle to move quickly, but the stacked portion of the ticket field 405 is scanned into the system to indicate where the vehicle is located (e.g., a drop zone or parking lot) in the event customer leaves before the vehicle is parked permanently.

Advantageously, creating a record for each ticket/vehicle recording vehicle movements, events, the responsibility valets, facilitates tracking vehicle location, keys, and assists in deploying valets to locations where their services are needed the most. For example, if a valet is not active in the system for a certain time period (e.g., 15 minutes) the system generates a message indicating that the employee has not been active. This helps managers manage employees at large locations, such as for example two entrances and three parking lots being services by 25 valet parkers. In addition, various other reports can be generated from the ticket records, for example a report showing how many cars arrive each hour.

The system may also include records associated with vehicle accidents/incidents and automate the process of obtaining accident information. In addition, the packet switched network architecture of the system allows a central remotely located office to monitor the activities at various parking locations, thus allowing management to oversee accounts from a remote location. Since the information is stored in a database, the information can be searched and various reports can be generated, including the financial performance of each parking location.

It is contemplated that the ticket may include a fifth field containing the primary numerical designator and get another secondary numerical designator. The fifth field may be scanned when the customer receives the vehicle (see step 320).

Although the present invention has been shown and described with respect to several preferred embodiments thereof, various changes, omissions and additions to the form and detail thereof, may be made therein, without departing from the spirit and scope of the invention.

What is claimed is:

1. A method of maintaining a valet parking database in a distributed computing system that includes a plurality of work stations each connected via a packet switched network to a computing device that accesses the valet parking database including information associated with vehicles that are valet parked, the method comprising:
assigning a uniquely associated tracking code to a vehicle to be valet parked;
creating a record in the valet parking database associated with the tracking code;
automatically activating a parking timer associated with the tracking code and its record to indicate the elapsed time since the vehicle to be valet parked has been assigned the tracking code but is not yet parked;
automatically issuing a warning message if the parking timer exceeds a first value indicating that the vehicle to be valet parked has not yet been parked;
updating the record to indicate that the vehicle has been parked and deactivating the parking timer when the vehicle to be valet parked has been parked;
receiving a retrieve vehicle request associated with the tracking code;
automatically retrieving the record from the valet parking database in response to the retrieve vehicle request;
automatically activating a key timer associated with the retrieved record to indicate the elapsed time since the record has been automatically retrieved in response to the retrieve vehicle request;
automatically issuing a missing key warning message if the key timer exceeds a second value indicating that the vehicle key has not yet been retrieved; and
updating the record and deactivating the key timer when the key associated with the vehicle has been located.
